(19) United States
(12) Patent Application Publication
(10) Pub. No.: US 2012/0152388 A1
(43) Pub. Date: Jun. 21, 2012

(54) Drain trap seal

(75) Inventor: William Anthony Stanaland, Montgomery, AL (US)

(73) Assignee: Jay R. Smith Manufacturing Company, Montgomery, AL (US)

(21) Appl. No.: 12/928,812

(22) Filed: Dec. 20, 2010

(51) Int. Cl. F16K 15/02

(52) U.S. Cl. 137/843

(57) ABSTRACT

An embodiment providing one or more improvements includes a drain trap seal which allows passage of fluids through a drain into a waste pipe while preventing backflow of fluid or gas from the waste pipe, as well as preventing evaporation or a water-containing trap seal located below the drain trap seal in the waste pipe.

Embodiment drain trap seals are easily installed in existing or new drains. Embodiments have two annular ring seals which insure a strong seal between the drain trap seal and the drain wall. Embodiments include a reinforcing band embedded below the annular ring seals which prevents failure of the annular ring seals.

### CROSS-REFERENCE TO RELATED APPLICATIONS

Not Applicable.

### STATEMENT REGARDING FEDERALLY SPONSORED RESEARCH OR DEVELOPMENT

Not Applicable.

### THE NAMES OF THE PARTIES TO A JOINT RESEARCH AGREEMENT

Not Applicable.

### INCORPORATION-BY-REFERENCE OF MATERIAL SUBMITTED ON A COMPACT DISC

Not Applicable.

### BACKGROUND OF THE INVENTION

1. Field of the Invention

Embodiments relate to drain trap seals which are used in conjunction with water-containing trap seals.

Description of Related Art including information disclosed under 37 CFR 1.97 and 1.98.

U.S. Pat. No. 2,348,097 discloses a floor drain having a valve which seals against backwater and against sewer gas. A resilient sealing member of rubber or synthetic rubber allows passage of water but prevents backflow of water or gas.

U.S. Pat. No. 2,629,393 discloses a check valve with cross-shaped cuts in a deformable material which allows one-way flow of fluid.

U.S. Pat. No. 2,822,819 discloses a cuspate check valve with 4 cusps.

U.S. Pat. No. 3,491,791 discloses a flutter valve and method of making.

U.S. Pat. No. 3,608,097 discloses a tricuspid prosthetic valve.

U.S. Pat. No. 4,594,739 discloses a protective drain for radioactive drains which uses a one-way tubular valve which opens when liquid is present but closes is submitted to down stream pressure.

U.S. Pat. No. 4,870,992 discloses a drain with a one piece deformable valving member.

U.S. Pat. No. 4,936,338 discloses a floating drain seal apparatus in which a float plug with a conical bottom surface forms a seal when water backs up into the drain.

U.S. Pat. No. 6,092,551 discloses a duckbill valve which can be manufactured in a single step.

U.S. Pat. No. 6,273,124 discloses two seal floor drains which use spring loaded stops or elastic diaphragms in series

U.S. Pat. No. 6,318,397 discloses a side port floor drain with multiple drain ports with flexible stops arrayed about a non-horizontal portion of the drain.

U.S. Pat. No. 6,719,004 discloses a drain with a check valve of elastomeric material which allows one way passage of fluid through the valve.

U.S. Pat. No. 6,795,987 discloses a check valve mounted in a collar which allows one way passage of fluids.

The foregoing examples of the related art and limitations related therewith are intended to be illustrative and not exclusive. Other limitations of the related art will become apparent to those of skill in the art upon a reading of the specification and a study of the drawings.

In particular, the prior art do not provide a drain trap seal with the advantages of embodiments of the present disclosure, that of allowing full flow through the drain, full access to the water-containing trap sea for maintenance, protection of the water-containing trap seal from evaporation, and protection of the structure from the escape of sewer gas if the water-containing trap seal fails.

### BRIEF SUMMARY OF THE INVENTION

The following embodiments and aspects thereof are described and illustrated in conjunction with systems, tool and methods which are meant to be exemplary and illustrative, not limiting in scope. In various embodiments, one or more of the above—described problems have been reduced or eliminated, while other embodiments are directed to other improvements.

Embodiments include a drain trap seal comprising a tubular body having a first and a second end, an annular reinforcing band embedded in the tubular body near the first end, the annular reinforcing band comprised of cold rolled steel, and two annular ring seals near the first end of the tubular body, the annular reinforcing band underlying the two ring seals. A quadruple goosebill seal comprised of four cuspids is attached to the second end of the tubular body. Each cuspid is comprised of a V-shaped cuspid body comprised of a cuspid shoulder, a left wing, and a right wing with a cuspid lip attached to each cuspid body, wherein each cuspid lip is capable of interaction with an adjacent cuspid lip of the same cuspid in a reversible sealing relationship. The tubular body, annular ring seals, and quadruple goosebill seal are collectively manufactured of a single piece of internally lubricated elastomer. The drain trap seal is capable of mounting in a drain having a drain wall and attached to a waste pipe, the ring seals are capable of having a sealing relationship with the drain wall, the drain trap seal is capable of allowing fluid flow through the drain into the waste pipe when there is four ounces or more of water in the drain, and the drain trap seal is capable of blocking backflow of gas or fluid from the waste pipe into the drain when the pressure in the waste pipe is equal to or higher than atmospheric pressure.

In addition to the exemplary aspects and embodiments described above, further aspects and embodiments will become apparent by reference to the drawings and by study of the following descriptions.

### BRIEF DESCRIPTION OF THE SEVERAL VIEWS OF THE DRAWING(S)

FIG. 1 is a perspective side view showing the top of an embodiment drain trap seal.

FIG. 2 is a perspective side view showing the bottom of an embodiment drain trap seal.

FIG. 3. is a top view of an embodiment drain trap seal installed in a drain.

FIG. 4 is a cross-section of an embodiment drain trap seal installed in a drain taken along line 4-4 of FIG. 3.

FIG. 5 is a bottom view of an embodiment drain trap seal.

FIG. 6 is a partial cross-section of an embodiment drain trap seal taken along line 6-6 of FIG. 2.

### DETAILED DESCRIPTION OF THE INVENTION

In this disclosure, the following terms are used: “Waste pipe” means a pipe leading from a drain to a sewer. “Drain trap seal” means a seal structure located in a floor drain. “Water-containing trap seal” means a generally U-shaped seal containing water or another liquid located in a waste pipe below a drain which prevents backflow of fluids or gases from the waste pipe through the drain. “Duckbill seal” means a seal made of flexible material with two lips which are together when the seal is closed and are apart when the seal is open. A duckbill seal is normally closed, blocking passage past the lips from either side of the seal. “Quadruple duckbill seal” means a goosebill seal made of flexible material with four sets of two lips which are pressed together when the seal is closed and are apart when the seal is opened:

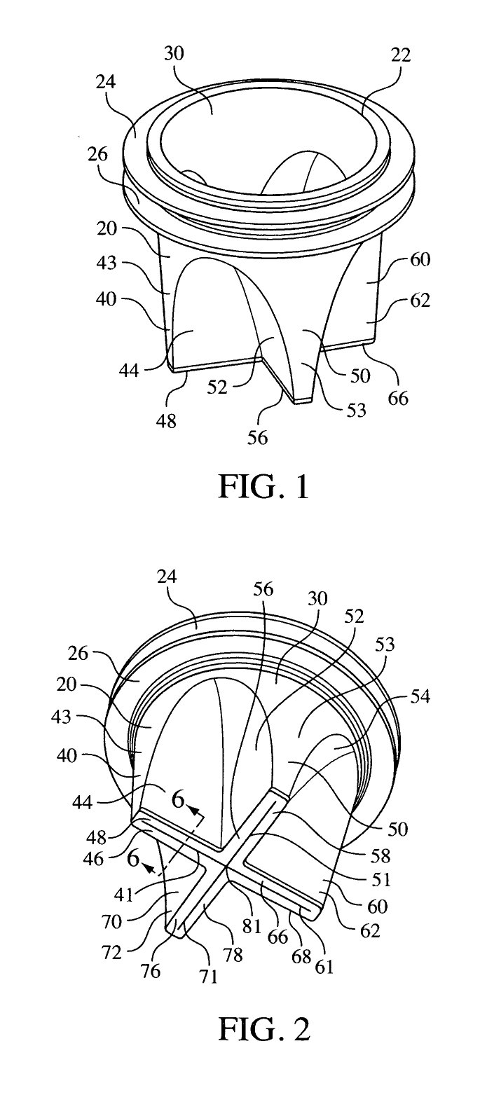

FIG. 1 is a perspective side view showing the top of an embodiment drain trap seal. FIG. 1 shows the exterior surfaces with the exception of the interior surface of the tubular body 30. Visible in FIG. 1 is an embodiment drain trap seal 20, rim 22 at the first end of the tubular body, upper annular ring seal 24, lower annular ring seal 26, and the tubular body 30, both annular ring seals located near the first end of the tubular body. Also visible is the first cuspid 40, first cuspid shoulder 43, first cuspid right wing 44, the cuspid wing convex in shape and attached to the cuspid shoulder 43 and to the second cuspid left wing 52, the first cuspid right wing lip 48 located at the bottom of the first cuspid right wing. Also visible is the second cuspid 50, second cuspid shoulder 53, second cuspid left wing 52, the cuspid wing convex in shape and attached to the cuspid shoulder 53 and to the first cuspid right wing 44, second cuspid left wing lip 56 is located at the bottom of the first cuspid right wing. Also visible is the third cuspid 60, the third cuspid left wing 62, the cuspid wing convex in shape and attached to the cuspid shoulder 43 and to the second cuspid right wing (not visible in FIG. 1). The third cuspid left wing lip 66 is located at the bottom of the third cuspid left wing 62.

FIG. 2 is a perspective side view showing the bottom of an embodiment drain trap seal. FIG. 2 shows the exterior surfaces of the drain trap seal. Visible in FIG. 2 is an embodiment drain trap seal 20, upper annular ring seal 24, lower annular ring seal 26, and the tubular body 30, both annular ring seals located near the first end of the tubular body. Also visible is the first cuspid 40, first cuspid shoulder 43, first cuspid right wing 44, the cuspid wing convex in shape and attached to the cuspid shoulder 43 and to the second cuspid left wing 52, the first cuspid right wing lip 48 located at the bottom of the first cuspid right wing. A first cuspid seal 41 is formed by the first cuspid left wing lip 46 and first cuspid right wing lip 48. Also visible is the second cuspid 50, second cuspid shoulder 53, second cuspid left wing 52, and the second cuspid right wing 54, the cuspid wings convex in shape and attached to the cuspid shoulder 53, the second cuspid left wing 52 also attached to the first cuspid right wing 44, a second cuspid left wing lip 56 and second cuspid right wing lip 58 are located at the bottom of the second cuspid left wing and second cuspid right wing, respectively. A second cuspid seal 51 is formed by the second cuspid left wing lip 56 and the second cuspid right wing lip 58. Also visible is the third cuspid 60, the third cuspid left wing 62, the cuspid wing convex in shape and attached to the cuspid shoulder (not visible in FIG. 2 and to the second cuspid right wing 54. The third cuspid left wing lip 66 is located at the bottom of the third cuspid left wing 62. The third cuspid right wing lip 68 is located at the bottom of the third cuspid right wing (not visible in FIG. 2). A third cuspid seal 61 is formed by the third cuspid left wing lip 66 and the third cuspid right wing lip 68. Also visible is the fourth cuspid 70, fourth cuspid left wing 72, the cuspid wing convex in shape and attached to the cuspid shoulder (not visible in FIG. 2) and to the first cuspid left wing (not visible in FIG. 2), the fourth cuspid left wing lip 76 located at the bottom of the fourth cuspid left wing 72. A fourth cuspid seal 71 is formed by the fourth cuspid left wing lip 76 and fourth cuspid right wing lip 78. All four cuspid seals intersect at 81.

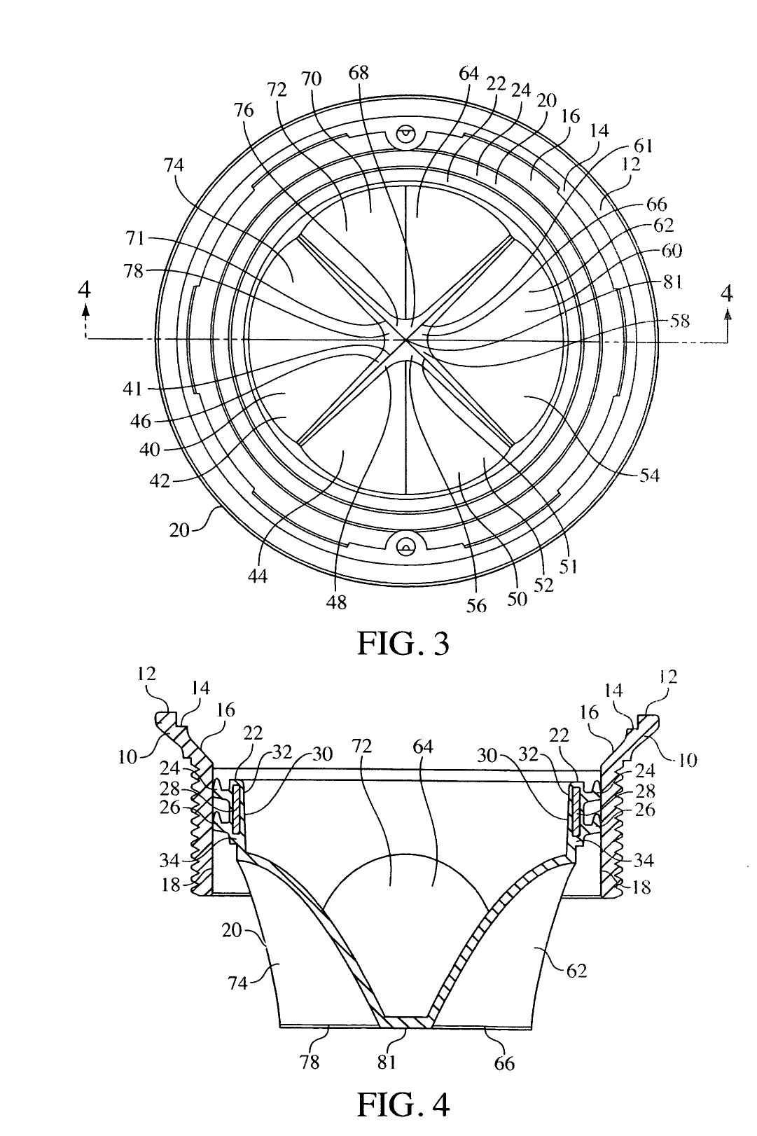

FIG. 3. is a top view of an embodiment drain trap seal installed in a floor drain. Visible in FIG. 3 is an embodiment floor drain 10 without a drain strainer. Visible is a top rim 12 of the floor drain, a recess 14 for a drain strainer, a sloping drain mouth 16, which connects with a vertical drain wall (not visible in FIG. 3). Features of the drain trap seal 20 visible in FIG. 3 are the internal surfaces, with the exception of the rim 22. Visible in FIG. 3 is the upper annular ring seal 24. Also visible is the first cuspid 40, first cuspid left wing 42, first cuspid left wing lip 46 located at the bottom of the first cuspid left wing 42. Also visible is the first cuspid right wing 44, the first cuspid right wing lip 48 located at the bottom of the first cuspid right wing 44. A first cuspid seal 41 is formed by the first cuspid left wing lip 46 and first cuspid right wing lip 48. Also visible is the second cuspid 50, second cuspid left wing 52, and the second cuspid right wing 54. A second cuspid left wing lip 56 and second cuspid right wing lip 58 are located at the bottom of the second cuspid left wing and second cuspid right wing, respectively. A second cuspid seal 51 is formed by the second cuspid left wing lip 56 and the second cuspid right wing lip 58. Also visible is the third cuspid 60, the third cuspid left wing 62, and third cuspid right wing 64. A third cuspid left wing lip 66 and third cuspid right wing lip 68 are located at the bottom of the third cuspid left wing and third cuspid right wing, respectively. A third cuspid seal 61 is formed by the third cuspid left wing lip 66 and the third cuspid right wing lip 68. Also visible is the fourth cuspid 70, the fourth cuspid left wing 72, and fourth cuspid right wing 74. A fourth cuspid left wing lip 76 and fourth cuspid right wing lip 78 are located at the bottom of the fourth cuspid left wing and fourth cuspid right wing, respectively. A fourth cuspid seal 71 is formed by the fourth cuspid left wing lip 76 and the fourth cuspid right wing lip 78. All four cuspid seals intersect at 81.

FIG. 4 is a cross-section of an embodiment drain trap seal installed in a drain taken along line 4-4 of FIG. 3. Visible in FIG. 4 is an embodiment floor drain 10 without a drain strainer. Visible is a top rim 12 of the floor drain, a recess 14 for a drain strainer, a sloping drain mouth 16, which connects with a vertical drain wall 18 which connects with a drain pipe (not shown in FIG. 4). Features of the drain trap seal 20 visible in FIG. 3 are the internal surfaces, with the exception of the rim 22. Visible in the embodiment drain trap seal in cross section in FIG. 4 is the trap seal rim 22, tubular body 30, first end 32 of the tubular body, and second end 34 of the tubular body. Also visible is the upper annular ring seal 24 and the lower annular ring seal 26. The annular ring seals are shown bent upward by contact with the vertical drain wall 18. Also visible is the annular reinforcing ring 28 located in the tubular body 30 and underlying the annular ring seals 24 and 26. Also visible attached at the second end 34 of the tubular body 30 is the third cuspid left wing 62, the third cuspid left wing lip 66, the third cuspid right wing 64, the fourth cuspid left wing 72, and the fourth cuspid right wing 74, and the fourth cuspid right wing lip 78. All four cuspid seals intersect at 81.

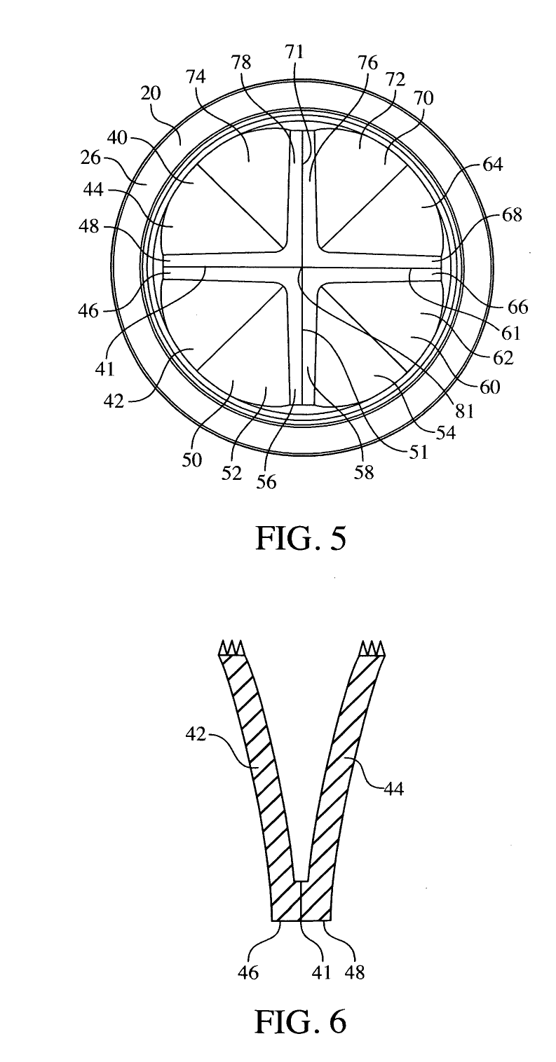

FIG. 5 is a bottom view of an embodiment drain trap seal 20. Visible in FIG. 5 is a lower annular ring seal 26. Also visible is the first cuspid 40, first cuspid left wing 42, first cuspid left wing lip 46 located at the bottom of the first cuspid left wing 42.

Also visible is the first cuspid right wing 44, the first cuspid right wing lip 48 located at the bottom of the first cuspid right wing 44. A first cuspid seal 41 is formed by the first cuspid left wing lip 46 and first cuspid right wing lip 48. Also visible is the second cuspid 50, second cuspid left wing 52, and the second cuspid right wing 54. A second cuspid left wing lip 56 and second cuspid right wing lip 58 are located at the bottom of the second cuspid left wing and second cuspid right wing, respectively. A second cuspid seal 51 is formed by the second cuspid left wing lip 56 and the second cuspid right wing lip 58. Also visible is the third cuspid 60, the third cuspid left wing 62, and third cuspid right wing 64. A third cuspid left wing lip 66 and third cuspid right wing lip 68 are located at the bottom of the third cuspid left wing and third cuspid right wing, respectively. A third cuspid seal 61 is formed by the third cuspid left wing lip 66 and the third cuspid right wing lip 68. Also visible is the fourth cuspid 70, the fourth cuspid left wing 72, and fourth cuspid right wing 74. A fourth cuspid left wing lip 76 and fourth cuspid right wing lip 78 are located at the bottom of the fourth cuspid left wing and fourth cuspid right wing, respectively. A fourth cuspid seal 71 is formed by the fourth cuspid left wing lip 76 and the fourth cuspid right wing lip 78. All four cuspid seals intersect at 81.

FIG. 6 is a partial cross-section of an embodiment drain trap seal taken along line 6-6 of FIG. 2. Visible in FIG. 6 is a first cuspid left wing 42 with attached first cuspid left wing lip 46, and the first cuspid right wing 44 with attached first cuspid right wing lip 48. Interaction between the lips form a reversible first cuspid seal 41.

Embodiment drain trap seals are made with the tubular body, ring seals, or goosebill seal comprised of any suitable soft, flexible, resilient material. Embodiments are made of acrylonitrile-butadiene rubber, polychloroprene, fluoroelastomers, ethylene propylene diene monomer, polyvinyl chloride, polyvinyl alcohol, high molecular weight polyethylene, perfluoroalkoxy polymer resin, fluorinated ethylene-propylene, or polytetrafluoroethylene. All materials of construction may be internally lubricated using compounds such as molybdenum sulfide or polytetrafluoroethylene.

Embodiments are made with the tubular body, ring seals, or goosebill seal comprised of acrylonitrile-butadiene rubber internally lubricated with molybdenum disulfide.

Embodiment drain trap seals are comprised of the tubular body, ring seals, and goosebill seal are collectively comprised of a single piece of material. In other embodiments the tubular body, ring seals, or goosebill seal are separately manufactured and subsequently assembled into an intact drain trap seal.

Embodiment drain trap seals include a annular reinforcing band comprised of any suitable strong, hard, resilient material. Embodiments are manufactured of iron, steel, cold rolled steel, cobalt, nickel, copper, or alloys thereof, or polystyrene, polyvinyl chloride, polypropylene, polyethylene, acrylonitrile butadiene styrene, polycarbonate, or polyamide.

Embodiment drain trap seals are intended for use as floor drain trap seals. They act as a backup safety device to prevent backflow of gases or liquids from the waste pipe into the structure. The primarily drain seal which prevents backflow is a U-shaped water-filled trap seal in the waste pipe below the drain trap seal. Embodiments also help preserve the integrity of the primary drain seal by preventing air leakage or evaporation of water or other liquid from the primary drain seal.

Embodiment drain trap seals allow the flow of drainage to enter the plumbing drainage system without any undo reduction in flow capacity, in particular, embodiment drain trap seals open when there is 4 ounces or more of water in the drain and close at a downstream pressure of liquid or gases from the waste pipe equal to or higher than atmospheric pressure. Embodiment drain trap seals also allow access to the primary drain seal for cleaning or inspection.

Embodiment drain trap seals include quadruple goosebill seals. Such embodiments provide a greater diameter than simple goosebill seals for maximum passage of liquids through the drain. In addition, quadruple goosebill seals allow a maximum diameter opening for inspection and maintenance of the primary drain seal.

Embodiment drain trap seals are compliant with industry standards.

While a number of exemplary aspects and embodiments have been discussed above, those of skill in the art will recognize certain modifications, permutations, additions and sub combinations thereof. It is therefore intended that the following appended claims and claims hereafter introduced are interpreted to include all such modifications, permutations, additions and sub-combinations as are within their true spirit and scope. The applicant or applicants have attempted to disclose all the embodiments of the invention that could be reasonably foreseen. There may be unforeseeable insubstantial modifications that remain as equivalents.

Drawings. 3 sheets.

### SEQUENCE LISTING

Not Applicable

I claim:

1. A drain trap seal comprising:
a tubular body having a first and a second end,
an annular reinforcing band embedded in the tubular body near the first end,
the annular reinforcing band comprised of a strong, hard, resilient material,
one or more soft, flexible, resilient annular ring seals near the first end of the tubular body,
the annular reinforcing band underlying the one or more annular ring seals,
a goosebill seal at the second end of the tubular body, and
all elements of the drain trap seal except the annular reinforcing band manufactured of an internally lubricated elastomer.

2. The drain trap seal of claim 1 wherein the tubular body, one or more ring seals, or goosebill seal are comprised of internally lubricated acrylonitrile-butadiene rubber.

3. The drain trap seal of claim 1 wherein the material of manufacture of the tubular body, one or more ring seals, or goosebill seal is selected from the group consisting of acrylonitrile-butadiene rubber, polychloroprene, fluoroelastomers, ethylene propylene diene monomer, polyvinyl chloride, polyvinyl alcohol, high molecular weight polyethylene, perfluoroalkoxy polymer resin, fluorinated ethylene-propylene, and polytetrafluoroethylene.

4. The drain trap seal of claim 2 wherein the acrylonitrile-butadiene rubber is internally lubricated with molybdenum disulfide.

5. The drain trap seal of claim 1 wherein the material of manufacture of the annular reinforcing band is selected from the group consisting of iron, steel, cold rolled steel, cobalt, nickel, copper or alloys thereof or polystyrene, polyvinyl chloride, polypropylene, polyethylene, acrylonitrile butadiene styrene, polycarbonate, and polyamide.

6. The drain trap seal of claim 1 wherein the annular reinforcing band is comprised of steel.

7. The drain trap seal of claim 1 wherein the annular reinforcing band is comprised of cold rolled steel.

8. The drain trap seal of claim 1 wherein the drain trap seal, when installed in a drain having a drain wall and attached to a waste pipe, is capable of allowing water flow through the drain trap seal from the drain to the waste pipe when there is four or more ounces of water in the drain.

9. The drain trap seal of claim 1 wherein the drain trap seal, when installed in a drain having a drain wall and attached to a waste pipe, is capable of preventing backflow of water or gas from the waste pipe to the drain when the pressure in the waste pipe is equal to or higher than atmospheric pressure.

10. The drain trap seal of claim 1 wherein the tubular body, one or more ring seals, and goosebill seal are collectively comprised of a single piece of material.

11. A drain trap seal comprising:
a tubular body having a first and a second end,
an annular reinforcing band embedded in the tubular body near the first end,
the annular reinforcing band comprised of a strong, hard, resilient material,
two annular ring seals near the first end of the tubular body,
the annular reinforcing band underlying the two annular ring seals,
a quadruple goosebill seal comprised of four cuspids,
each cuspid comprised of a V-shaped cuspid body attached to the second end of the tubular body and a V-shaped cuspid lip attached to each cuspid body, wherein each cuspid lip interacts with an adjacent cuspid lip in a reversible sealing relationship, and the tubular body, annular ring seals, and quadruple goosebill seal manufactured of an internally lubricated elastomer.

12. The drain trap seal of claim 11 wherein the tubular body, two ring seals, or quadruple goosebill seal are comprised of internally lubricated acrylonitrile-butadiene rubber.

13. The drain trap seal of claim 11 wherein the material of manufacture of the tubular body, one or more ring seals, or goosebill seal is selected from the group consisting of acrylonitrile-butadiene rubber, polychloroprene, fluoroelastomers, ethylene propylene diene monomer, polyvinyl chloride, polyvinyl alcohol, high molecular weight polyethylene, perfluoroalkoxy polymer resin, fluorinated ethylene-propylene, and polytetrafluoroethylene.

14. The drain trap seal of claim 11 wherein the material of manufacture of the annular reinforcing band is selected from the group consisting of iron, steel, cold rolled steel, cobalt, nickel, copper or alloys thereof or polystyrene, polyvinyl chloride, polypropylene, polyethylene, acrylonitrile butadiene styrene, polycarbonate, and polyamide.

15. The drain trap seal of claim 11 wherein the annular reinforcing band is comprised of steel.

16. The drain trap seal of claim 11 wherein the annular reinforcing band is comprised of cold rolled steel.

17. The drain trap seal of claim 11 wherein the drain trap seal, when installed in a drain having a drain wall and attached to a waste pipe, is capable of allowing water flow through the drain trap seal from the drain to the waste pipe when there is four or more ounces of water in the drain.

18. The drain trap seal of claim 11 wherein the drain trap seal, when installed in a drain having a drain wall and attached to a waste pipe, prevents backflow of water or gas from the waste pipe to the drain when the pressure in the waste pipe is equal to or higher than atmospheric pressure.

19. The drain trap seal of claim 11 wherein the tubular body, two ring seals, and quadruple goosebill seal are collectively comprised of a single piece of material.

20. A drain trap seal comprising:
a tubular body having a first and a second end,
an annular reinforcing band embedded in the tubular body near the first end,
the annular reinforcing band comprised of cold rolled steel,
two annular ring seals near the first end of the tubular body,
the annular reinforcing band underlying the two ring seals,
a quadruple goosebill seal comprised of four cuspids, the goosebill sear attached to the second end of the tubular body, each cuspid comprised of a V-shaped cuspid body comprised of a cuspid shoulder, a left wing, and a right wing with a cuspid lip attached to each cuspid body, wherein each cuspid lip was capable of interaction with an adjacent cuspid lip of the same cuspid in a reversible sealing relationship,
the tubular body, annular ring seals, and quadruple goosebill seal collectively manufactured of a single piece of acrylonitrile-butadiene internally lubricated with molybdenum disulfide,
the drain trap seal capable of mounting in a drain having a drain wall and attached to a waste pipe,
the ring seals capable of having a sealing relationship with the drain wall,
the drain trap seal capable of allowing fluid flow through the drain into the waste pipe when there is four ounces or more of water in the drain, and
the drain trap seal capable of blocking backflow of gas or fluid from the waste pipe into the drain when the pressure in the waste pipe is equal to or higher than atmospheric pressure.
